(19) United States
(12) Patent Application Publication
(10) Pub. No.: US 2019/0281803 A1
(43) Pub. Date: Sep. 19, 2019

(54) Minnow Holding Assembly

(71) Applicant: Michael C. Hopp, Sioux Falls, SD (US)

(72) Inventor: Michael C. Hopp, Sioux Falls, SD (US)

(21) Appl. No.: 15/920,141

(22) Filed: Mar. 13, 2018

(51) Int. Cl. A01K 97/04; A01K 97/05

(52) U.S. Cl. CPC A01K 97/045; A01K 97/05

(57) ABSTRACT

A minnow holding assembly includes a tubular member having a first end, a second end and a perimeter wall extending between the first and second ends. Each of the first and second ends is open. The tubular member includes a first portion including the first end and a second portion including the second end. The perimeter wall of the first portion has a plurality of elongated slits therein extending into the first end and toward the second portion. The slits expose portions of a minnow held within the tubular member such that a hook can extend through the slits and through the minnow.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to minnow holders and more particularly pertains to a new minnow holder for retaining a minnow in a position that facilitates the hooking of the minnow.

### BRIEF SUMMARY OF THE INVENTION

An embodiment of the disclosure meets the needs presented above by generally comprising a tubular member having a first end, a second end and a perimeter wall extending between the first and second ends. Each of the first and second ends is open. The tubular member includes a first portion including the first end and a second portion including the second end. The perimeter wall of the first portion has a plurality of elongated slits therein extending into the first end and toward the second portion. The slits are configured to expose portions of a minnow held within the tubular member such that a hook can extend through the slits and through the minnow.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a minnow holding assembly according to an embodiment of the disclosure.

FIG. 2 is a cross-sectional view of an embodiment of the disclosure taken along line 2-2 of FIG. 1.

FIG. 3 is a rear isometric view of an embodiment of the disclosure.

FIG. 4 is a front isometric view of a container of an embodiment of the disclosure.

FIG. 5 is a side isometric view of a cover of an embodiment of the disclosure.

FIG. 6 is a cross-sectional view of an embodiment of the disclosure taken along line 6-6 of FIG. 3.

FIG. 7 is a front isometric view of an embodiment of the disclosure.

### DETAILED DESCRIPTION OF THE INVENTION

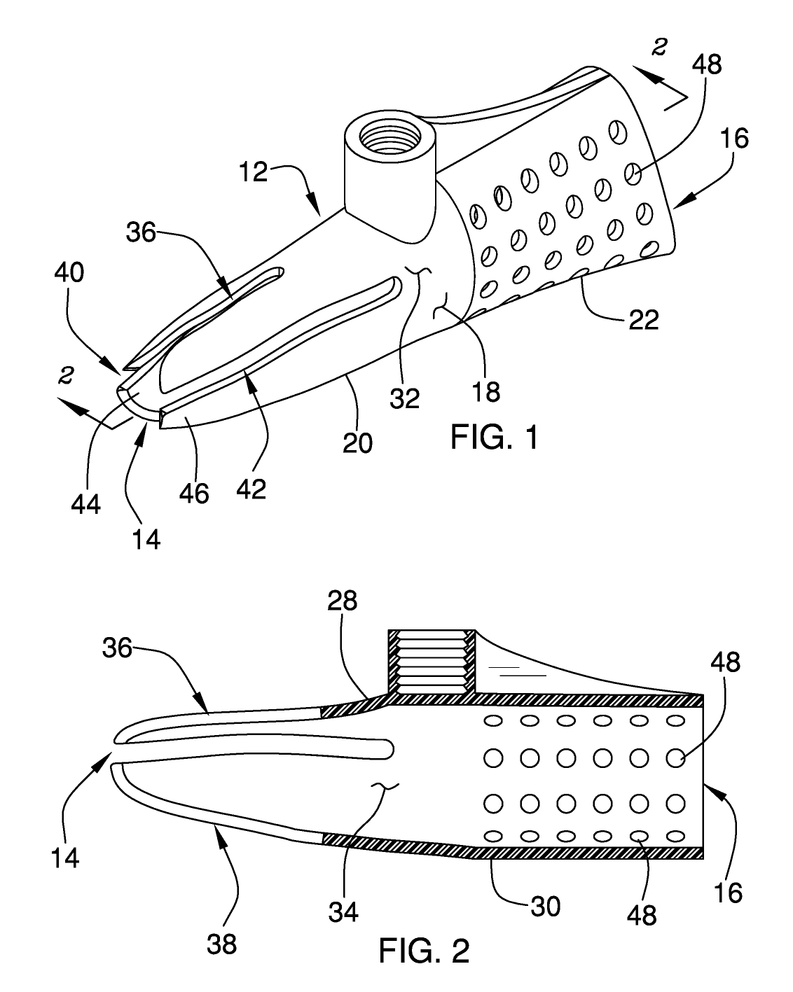

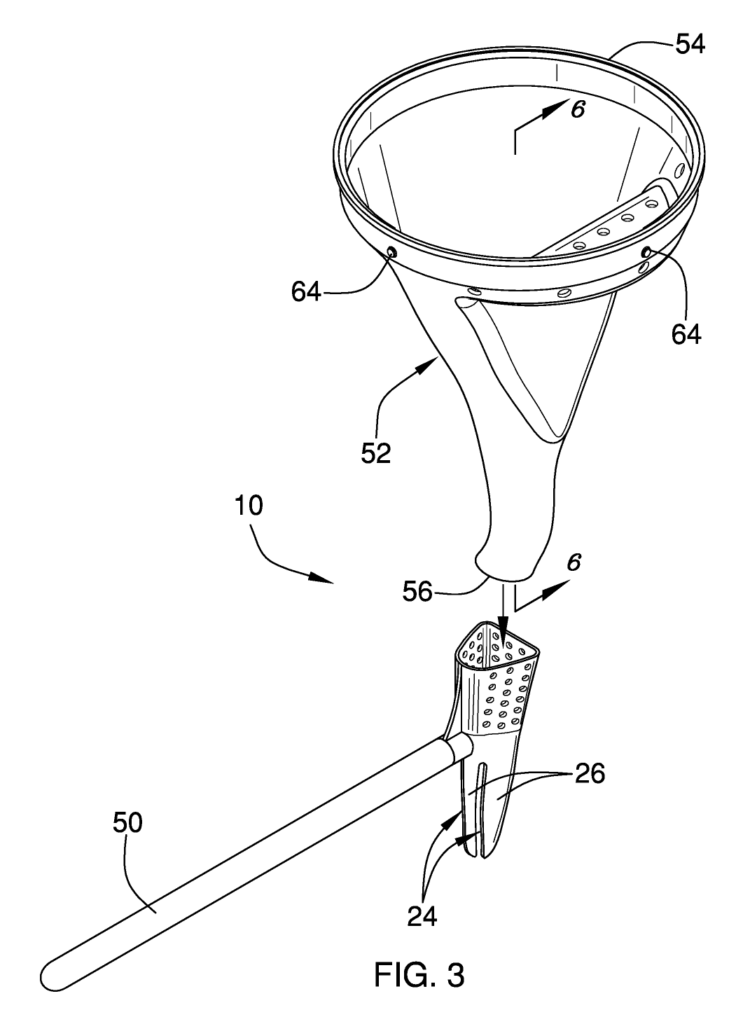

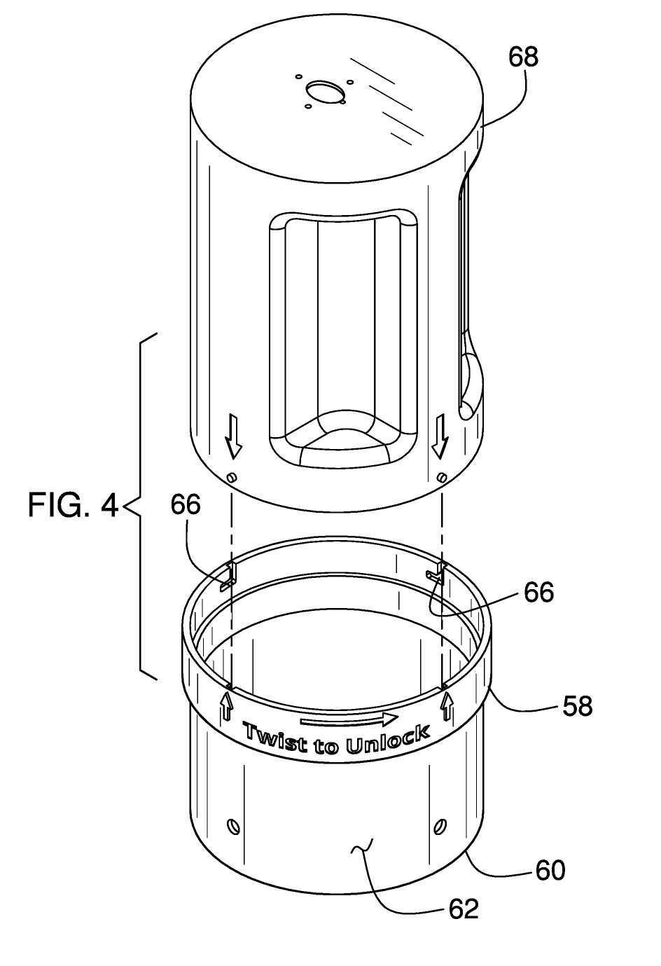

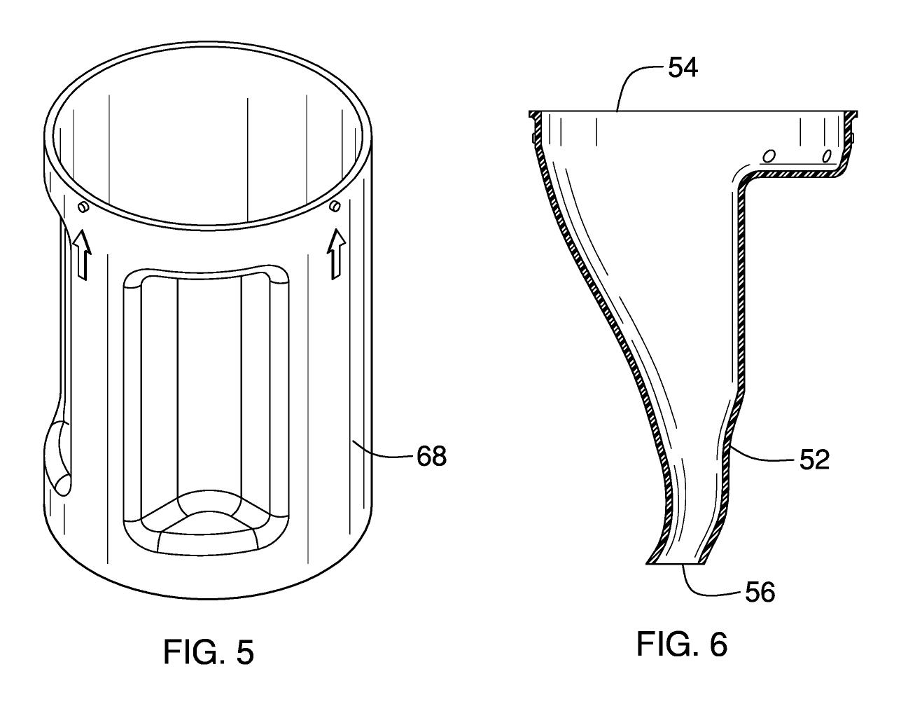

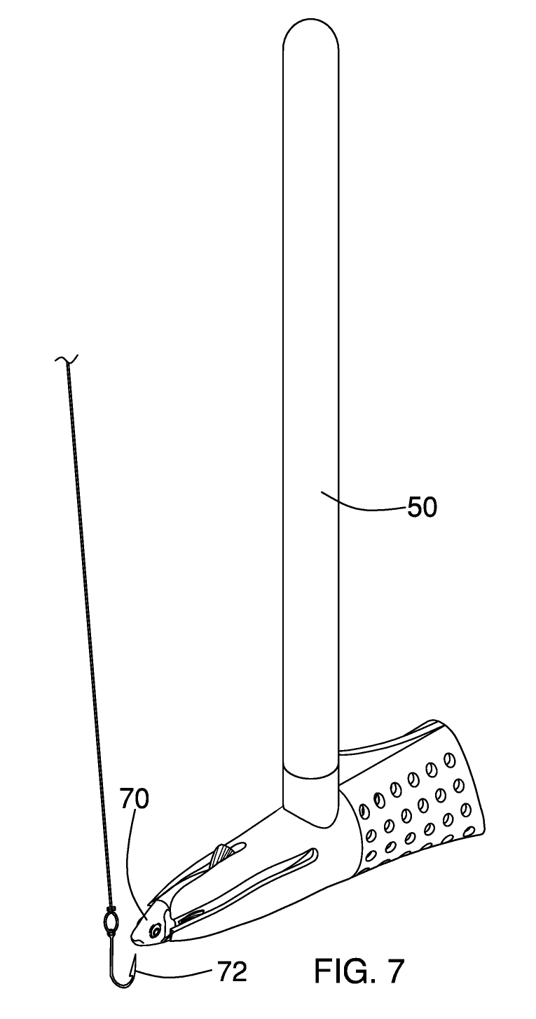

With reference now to the drawings, and in particular to FIGS. 1 through 7 thereof, a new minnow holder embodying the principles and concepts of an embodiment of the disclosure and generally designated by the reference numeral 10 will be described.

As best illustrated in FIGS. 1 through 7, the minnow holding assembly 10 generally comprises a tubular member 12 that has a first end 14, a second end 16 and a perimeter wall 18 extending between the first 14 and second 16 ends. Each of the first 14 and second 16 ends is open. The tubular member 12 includes a first portion 20 including the first end 14 and a second portion 22 including the second end 16. The perimeter wall 18 of the first portion 20 has a plurality of elongated slits 24 therein extending into the first end 14 and toward the second portion 22. The slits 24 are configured to expose portions of a minnow 70 held within the tubular member 12 such that a hook 72 can extend through the slits 24 and through the minnow 70. The slits 24 also allow the minnow 70 to pass through the first end 14 as sections 26 of the perimeter wall 18 open outwardly as the minnow 70 is pulled through the first end 14. The tubular member 12 is constructed of resiliently flexible material, such as a plastic or rubber material, so that the sections 26 remain generally in place to prevent a minnow 70 from sliding through the first end 14 but which can be bent outwardly to allow the minnow 70 to be pulled through the first end 14. The first portion 20 tapers inwardly from the second portion 22 to the first end 14.

The perimeter wall 18 includes an upper wall 28, a lower wall 30, a first lateral wall 32 and a second lateral wall 34. The slits 24 include an upper slit 36 positioned in the upper wall 28 and a lower slit 38 positioned in the lower wall 30. The slits 24 may further include a first lateral slit 40 positioned in the first lateral wall 32 and a second lateral slit 42 positioned in the second lateral wall 34. A first lower section 44 of the perimeter wall 18 is defined between the lower slit 38 and the first lateral slit 40 and a second lower section 46 of the perimeter wall 18 is defined between the lower slit 38 and the second lateral slit 42. The lower wall 30 of the first 44 and second 46 lower sections each is curved upwardly adjacent to the first end 14 to help to retain the minnow 70 within the first portion 20 of the tubular member 12. The second portion 22 of the tubular member 12 may have a plurality of apertures 48 extending therethrough and the lower wall 30 of the second portion 22 is planar.

A handle 50 is attached to the tubular member 12. The handle 50 extends upwardly from the upper wall 28 and may be positioned between the first 14 and second 16 ends. The handle 50 may be threadably coupled to the tubular member 12 so that the handle 50 is removable from the tubular member 12 for storage purposes.

A funnel 52 is provided which includes a receiving end 54 and a dispensing end 56. Each of the receiving 54 and dispending 56 ends is open. The funnel 52 tapers inwardly from the receiving end 54 to the dispensing end 56. The dispensing end 56 is removably extendable into the second end 16 of the tubular member 12 as shown in FIG. 3. In this manner, the funnel 52 is configured to direct the minnow 70 into the second end 16 of the tunnel member 12.

A container 58 may be provided which includes a bottom wall 60 and an outer wall 62 that is attached to and extends upwardly from the bottom wall 60. The container 58 is fluidly couplable to the receiving end of the funnel 52. Moreover, the funnel 52 may include first mating members 64 that are engageable with second mating members 66 on the container 58 to connect the receiving end 54 to the container 58. The container 58 is configured to deliver the minnow 70 into the funnel 52. A cover 68 may be provided which may be secured to the container 58 to allow the funnel 52, handle 50 and tubular member 12 to be stored within the container 58 and cover 68.

In use, the funnel 52 is engaged with the tubular member 12 and a minnow 70 is placed into the funnel 52 so that the minnow 70 moves from the funnel 52 and into the tubular member 12. The minnow 70 will move forward so that it becomes stuck in the first end 14 of the tubular member 12. In this position, the head of the minnow 70 is exposed so that a hook 72 can be extended through the minnow 70. The tubular member 12 securely holds the minnow 70 so that it cannot move during the hooking process and prevents the need to attempt to grip the minnow 70 by hand.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A minnow holding assembly configured to retain a minnow such that the minnow may be easily hooked with a fishing hook, said assembly comprising:
a tubular member having a first end, a second end and a perimeter wall extending between said first and second ends, each of said first and second ends being open, said tubular member including a first portion including said first end and a second portion including said second end, said perimeter wall of said first portion having a plurality of elongated slits therein extending into said first end and toward said second portion, wherein said slits are configured to expose portions of a minnow held within said tubular member such that a hook can extend through said slits and through the minnow.

2. The minnow holding assembly according to claim 1, wherein said perimeter wall includes an upper wall, a lower wall, a first lateral wall and a second lateral wall, said slits including an upper slit positioned in said upper wall, said slits including a lower slit positioned in said lower wall.

3. The minnow holding assembly according to claim 2, wherein said slits including a first lateral slit positioned in said first lateral wall and a second lateral slit positioned in said second lateral wall.

4. The minnow holding assembly according to claim 2, wherein a first lower section of said perimeter wall being defined between said lower slit and said first lateral slit, a second lower section of said perimeter wall being defined between said lower slit and said second lateral slit, said lower wall of said first and second lower sections each being curved upwardly adjacent to said first end.

5. The minnow holding assembly according to claim 1, wherein said second portion of said tubular member has a plurality of apertures extending therethrough.

6. The minnow holding assembly according to claim 1, wherein said lower wall of said second portion is planar.

7. The minnow holding assembly according to claim 1, further including a handle being attached to said tubular member.

8. The minnow holding assembly according to claim 7, wherein said handle extends upwardly from said upper wall, said handle being positioned between said first and second ends.

9. The minnow holding assembly according to claim 8, wherein said handle is threadably coupled to said tubular member and being removable from said tubular member.

10. The minnow holding assembly according to claim 1, further including a funnel including a receiving end and a dispensing end, each of said receiving and dispending ends being open, said funnel tapering inwardly from said receiving end to said dispensing end, said dispensing end being removably extendable into said second end of said tubular member, wherein said funnel is configured to direct the minnow into said second end of said tunnel member.

11. The minnow holding assembly according to claim 10, further including a container having a bottom wall and an outer wall being attached to and extending upwardly from said bottom wall, said container being fluidly couplable to said receiving end of said funnel, said container being configured to deliver the minnow into said funnel.

12. A minnow holding assembly configured to retain a minnow such that the minnow may be easily hooked with a fishing hook, said assembly comprising:
a tubular member having a first end, a second end and a perimeter wall extending between said first and second ends, each of said first and second ends being open, said tubular member including a first portion including said first end and a second portion including said second end, said perimeter wall of said first portion having a plurality of elongated slits therein extending into said first end and toward said second portion, wherein said slits are configured to expose portions of a minnow held within said tubular member such that a hook can extend through said slits and through the minnow, said perimeter wall including an upper wall, a lower wall, a first lateral wall and a second lateral wall, said slits including an upper slit positioned in said upper wall, said slits including a lower slit positioned in said lower wall, said slits including a first lateral slit positioned in said first lateral wall and a second lateral slit positioned in said second lateral wall, a first lower section of said perimeter wall being defined between said lower slit and said first lateral slit, a second lower section of said perimeter wall being defined between said lower slit and said second lateral slit, said lower wall of said first and second lower sections each being curved upwardly adjacent to said first end, said second portion of said tubular member having a plurality of apertures extending therethrough, said lower wall of said second portion being planar;
a handle being attached to said tubular member, said handle extending upwardly from said upper wall, said handle being positioned between said first and second ends, said handle being threadably coupled to said tubular member and being removable from said tubular member;
a funnel including a receiving end and a dispensing end, each of said receiving and dispending ends being open, said funnel tapering inwardly from said receiving end to said dispensing end, said dispensing end being removably extendable into said second end of said tubular member, wherein said funnel is configured to direct the minnow into said second end of said tunnel member; and
a container having a bottom wall and an outer wall being attached to and extending upwardly from said bottom wall, said container being fluidly couplable to said receiving end of said funnel, said container being configured to deliver the minnow into said funnel.
